(19) United States
(12) Patent Application Publication
(10) Pub. No.: US 2023/0265706 A1
(43) Pub. Date: Aug. 24, 2023

(54) VEHICLE OPENING AND CLOSING BODY CONTROL DEVICE

(71) Applicant: AISIN CORPORATION, Kariya (JP)

(72) Inventors: Kenta ENYA, Kariya-shi (JP); Takashi KAINO, Kariya-shi (JP); Kohei KOJIMA, Kariya-shi (JP)

(73) Assignee: AISIN CORPORATION, Kariya (JP)

(21) Appl. No.: 18/148,718

(22) Filed: Dec. 30, 2022

(30) Foreign Application Priority Data
Feb. 18, 2022 (JP) 2022-024071

(51) Int. Cl. E05F 15/70; B60J 5/04; G07C 5/08; E05F 15/63

(52) U.S. Cl. CPC E05F 15/70; B60J 5/047; G07C 5/0808; E05F 15/63; E05Y 2201/434; E05Y 2201/686; E05Y 2400/40; E05Y 2400/354; E05Y 2900/531

(57) ABSTRACT

A vehicle opening and closing body control device includes a drive control unit that opens and closes an opening and closing body of a vehicle using a motor as a drive source, wherein the opening and closing body performs the opening and closing operation based on an operation of a link mechanism formed by first and second link arms having a first rotation connection point with respect to a vehicle body and a second rotation connection point with respect to the opening and closing body, wherein an opening and closing body engagement portion is provided at a closed-side end of the opening and closing body, and an engagement failure detector that detects a failure in engagement of the opening and closing body engagement portion with the vehicle body engagement portion based on a change in a motor current value in the specific operation section at a time of full-closing control of the opening and closing body.

### CROSS REFERENCE TO RELATED APPLICATIONS

This application is based on and claims priority under 35 U.S.C. § 119 to Japanese Patent Application No. 2022-024071, filed on Feb. 18, 2022, the entire content of which is incorporated herein by reference.

### TECHNICAL FIELD

The present disclosure relates to a vehicle opening and closing body control device.

### BACKGROUND DISCUSSION

A vehicle door device including first and second link arms having a first rotation connection point with respect to a known vehicle body and a second rotation connection point with respect to a door of the vehicle is disclosed in JP 2006-90097 A. In such a door device, the door provided in the door opening is opened and closed based on the operation of the link mechanism formed by the first and second link arms. For example, Patent Literature 1 describes a configuration in which each link arm forming the link mechanism is stored outside a door opening attached to a terminal portion of a side portion of a vehicle body and inside a weather strip attached to a vehicle interior of the door when the door is in a closed state.

However, in the configuration in which the opening and closing body of the vehicle is opened and closed using the link mechanism as described above, rotation of the opening and closing body is allowed around the second rotation connection point. Therefore, there is a possibility that the opening and closing body swings due to input of an external force or the like. Then, the swing generated in the opening and closing body may hinder the smooth operation.

A need thus exists for a vehicle opening and closing body control device which is not susceptible to the drawback mentioned above.

### SUMMARY

A vehicle opening and closing body control device includes a drive control unit that opens and closes an opening and closing body of a vehicle using a motor as a drive source, wherein the opening and closing body performs the opening and closing operation based on an operation of a link mechanism formed by first and second link arms having a first rotation connection point with respect to a vehicle body and a second rotation connection point with respect to the opening and closing body, wherein an opening and closing body engagement portion is provided at a closed-side end of the opening and closing body, wherein a vehicle body engagement portion is provided at a closed-side end, of a vehicle body opening, that the closed-side end of the opening and closing body comes into contact with and separates from based on the opening and closing operation of the opening and closing body, wherein one of the opening and closing body engagement portion and the vehicle body engagement portion includes a guide engagement portion, wherein the other of the opening and closing body engagement portion and the vehicle body engagement portion includes a guide groove having a pair of side wall portions facing each other and extending in an opening and closing operation direction of the opening and closing body, wherein when the opening and closing body engagement portion is correctly engaged with the vehicle body engagement portion in a specific operation section set in a vicinity of a fully closed position of the opening and closing body, an opening and closing operation of the opening and closing body is guided in a state where the guide engagement portion is disposed in the guide groove, and an engagement failure detector that detects a failure in engagement of the opening and closing body engagement portion with the vehicle body engagement portion based on a change in a motor current value in the specific operation section at a time of full-closing control of the opening and closing body.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a door device;

FIG. 2 is a perspective view of the door device;

FIG. 3 is a plan view of first and second link arms forming a link mechanism;

FIG. 4 is a plan view of the first and second link arms forming the link mechanism;

FIG. 5 is a plan view of the first and second link arms forming the link mechanism;

FIG. 6 is a plan view of the first and second link arms forming the link mechanism;

FIG. 7 is a schematic configuration diagram of a door engagement portion and a vehicle body engagement portion;

FIG. 8 is an explanatory view illustrating arrangement of the door engagement portion and the vehicle body engagement portion;

FIG. 9 is a perspective view of a door and a door opening illustrating arrangement of the door engagement portion and the vehicle body engagement portion;

FIG. 10 is a plan view of a joint link mechanism constituting a connection length variable mechanism;

FIG. 11 is a plan view of the joint link mechanism constituting the connection length variable mechanism;

FIG. 12 is a control block diagram of the door device;

FIG. 13 is a schematic view of a case where the door engagement portion is correctly engaged with the vehicle body engagement portion;

FIG. 14 is a schematic view of a case where a failure in engagement of a door engagement portion with a vehicle body engagement portion occurs;

FIG. 15 is a graph showing a change in a motor current value in a specific operation section set in the vicinity of a fully closed position;

FIG. 16 is a flowchart illustrating a processing procedure when a characteristic change occurring in a motor current value in a specific operation section is detected;

FIG. 17 is a flowchart illustrating a processing procedure of engagement failure determination by detection of a first rising position;

FIG. 18 is a flowchart illustrating a processing procedure of engagement failure determination by detection of a first peak position;

FIG. 19 is a flowchart illustrating a processing procedure of engagement failure determination by detection of a second rising position;

FIG. 20 is a flowchart showing a processing procedure of engagement failure determination by detection of a maximum value detection final position; and

FIG. 21 is a flowchart illustrating a processing procedure of reverse control executed when an engagement failure is detected.

### DETAILED DESCRIPTION

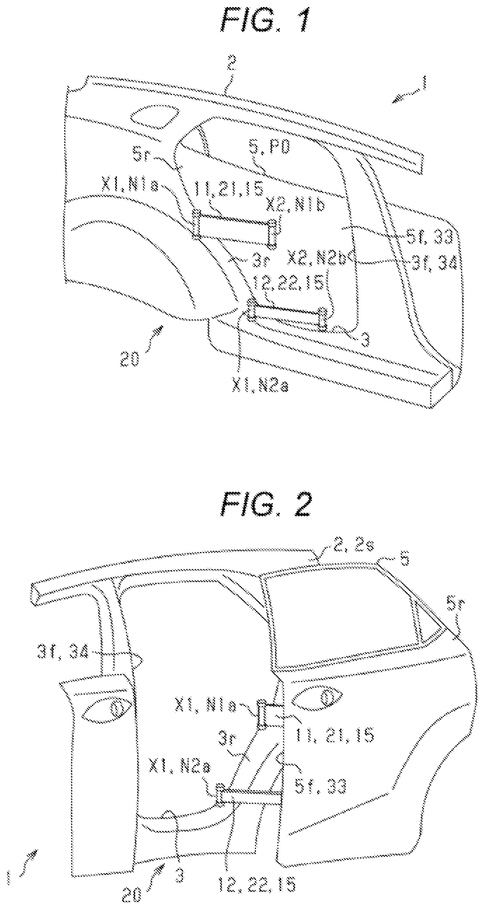

Hereinafter, an embodiment in which the vehicle opening and closing body control device is embodied as a door device of a vehicle will be described with reference to the drawings. As illustrated in FIGS. 1 and 2, a vehicle 1 of the present embodiment includes a door opening 3 provided on a side face 2s of a vehicle body 2. The door opening 3 is provided with a first link arm 11 and a second link arm 12 that support a door 5 of the vehicle 1 at the door opening 3.

More specifically, in the vehicle 1 of the present embodiment, each of the first and second link arms 11 and 12 has a first rotation connection point X1 with respect to the vehicle body 2 and a second rotation connection point X2 with respect to the door 5. Specifically, the first link arm 11 is connected to the vehicle body 2 in a state of being pivotally supported by a support shaft N1a extending in the vertical direction (in each drawing, vertical direction), and is connected to the door 5 in a state of being pivotally supported by a support shaft N1b extending in the vertical direction. The second link arm 12 is connected to the vehicle body 2 in a state of being pivotally supported by a support shaft N2a extending in the vertical direction, and connected to the door 5 in a state of being pivotally supported by a support shaft N2b extending in the vertical direction.

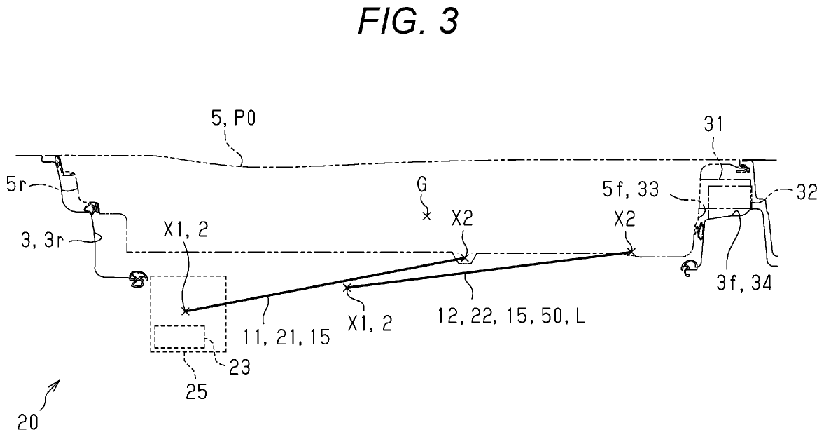

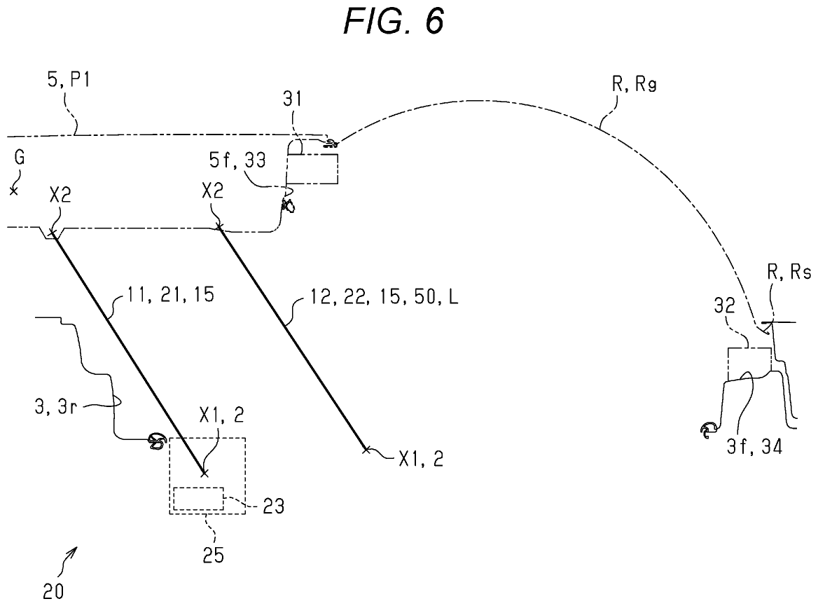

That is, as illustrated in FIGS. 3 to 6, in the vehicle 1 of the present embodiment, the first and second link arms 11 and 12 form a link mechanism 15 having a configuration as a four-bar link. The vehicle 1 of the present embodiment is configured such that the door 5 supported by the door opening 3 is opened and closed based on the operation of the link mechanism 15.

More specifically, as illustrated in FIGS. 1 and 2, the vehicle 1 of the present embodiment uses the first and second link arms 11 and 12 to support the door 5 in the door opening 3 on the vehicle rear side (Left side in FIG. 1, right side in FIG. 2). In the vehicle 1 of the present embodiment, each of the first and second link arms 11 and 12 has the first rotation connection point X1 rotatably connected to the vehicle body 2 in the vicinity of a rear edge 3r of the door opening 3. In the vehicle 1 of the present embodiment, the first and second link arms 11 and 12 are disposed away from each other in the vertical direction.

In the vehicle 1 of the present embodiment, the first link arm 11 is provided above the second link arm 12. The first link arm 11 has the second rotation connection point X2 rotatably connected to the door 5 at a substantially central position in the front-rear direction of the door 5. On the other hand, the second link arm 12 has the second rotation connection point X2 connected to the door 5 in the vicinity of a front end 5f of the door 5. Then, in the vehicle 1 of the present embodiment, a door device 20 in which the door 5 is opened and closed based on the operation of the link mechanism 15 formed by the first and second link arms 11 and 12 is formed.

Specifically, as illustrated in FIGS. 3 to 6, in the door device 20 of the present embodiment, when the door 5 is opened, the first and second link arms 11 and 12 rotate in the counterclockwise direction in each drawing around the first rotation connection point X1. As a result, the door 5 of the vehicle 1 supported by the first and second link arms 11 and 12 performs an opening operation toward the vehicle rear direction (left side in each drawing).

In addition, in the door device 20 of the present embodiment, when the door 5 is closed, the first and second link arms 11 and 12 rotate in the clockwise direction in each drawing around the first rotation connection point X1. Thus, the door 5 of the vehicle 1 supported by the first and second link arms 11 and 12 is configured to perform a closing operation toward the vehicle front direction (right side in each drawing).

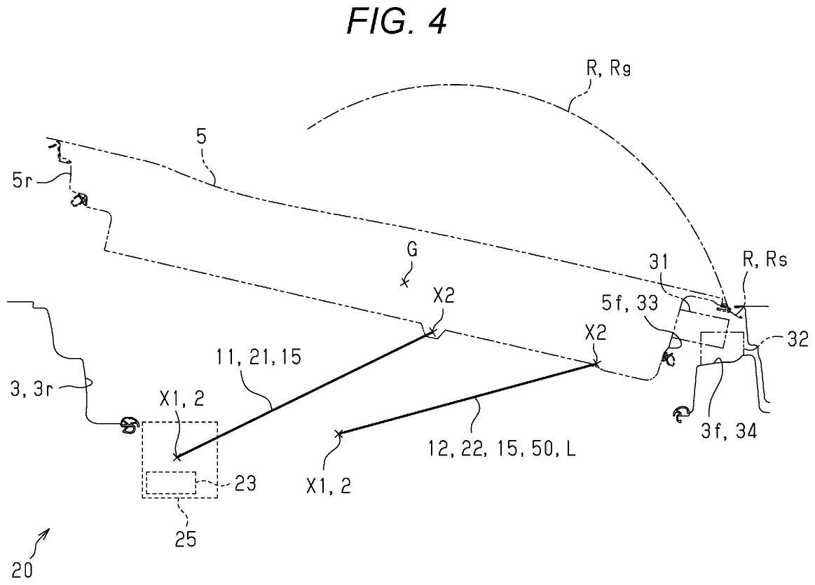

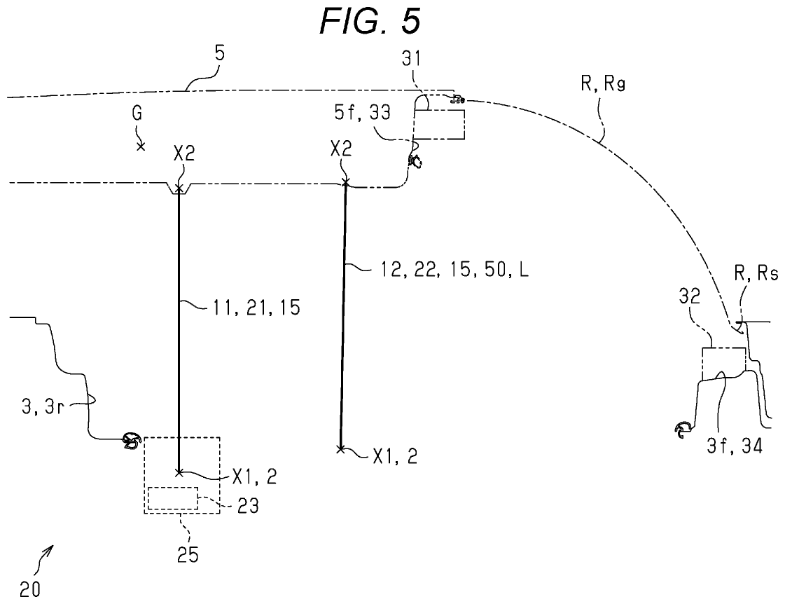

Furthermore, in the door device 20 of the present embodiment, an opening and closing operation trajectory R of the door 5 is defined so as to draw an arc-shaped trajectory Rg based on the operation of the link mechanism 15 formed by the first and second link arms 11 and 12. That is, as illustrated in FIG. 5, at the intermediate position where the first and second link arms 11 and 12 extend in the vehicle width direction (in FIGS. 3 to 6, vertical direction), the movement component in the vehicle front-rear direction increases. As illustrated in FIGS. 3 and 4, the closer the opening and closing operation position of the door 5 is to a fully closed position P0, the more the first and second link arms 11 and 12 extend in the vehicle front-rear direction (left and right direction in FIGS. 3 to 6), so that the movement component in the vehicle width direction increases.

Further, in the door device 20 of the present embodiment, the first link arm 11 has the second rotation connection point X2 with respect to the door 5 at a position closer to the center of gravity G than the second link arm 12. That is, in the door device 20 of the present embodiment, the first link arm 11 is thus served as a main link 21 that supports a larger door load. The second link arm 12 is served as a sub-link 22 in which the acting door load is relatively small.

In the door device 20 of the present embodiment, the first link arm 11 has a larger outer shape than the second link arm 12. Thus, the door device 20 of the present embodiment is configured to impart high support rigidity to the first link arm 11 served as the main link 21.

In addition, the door device 20 of the present embodiment includes an actuator 25 that rotationally drives the first link arm 11 using a motor 23 as a drive source. In the door device 20 of the present embodiment, the actuator 25 is provided at the proximal end of the first link arm 11. That is, the actuator 25 of the present embodiment drives the link mechanism 15 formed by the first link arm 11 and the second link arm 12 in such a manner as to rotate the first link arm 11. Thus, the door device 20 of the present embodiment can open and close the door 5 based on the driving force of the actuator 25.

As illustrated in FIGS. 3 to 7, the door device 20 of the present embodiment includes a door engagement portion 31 provided at the front end 5f of the door 5 and a vehicle body engagement portion 32 provided at the front edge 3f of the door opening 3. That is, in the vehicle 1 of the present embodiment, the door engagement portion 31 is provided at a closed-side end 33 located on the closing operation side of the door 5 that opens and closes the door opening 3 of the vehicle 1 based on the operation of the link mechanism 15 formed by the first and second link arms 11 and 12. Further, the vehicle body engagement portion 32 is provided at a closed-side end 34 of the door opening 3 that the closed-side end 33 of the door 5 comes into contact with and separates from, that is, approaches or is away from, based on the opening and closing operation of the door 5 moving in the vehicle front-rear direction. The door device 20 of the present embodiment is configured such that the door engagement portion 31 and the vehicle body engagement portion 32 are engaged with each other in a state where the door 5 is in the vicinity of the fully closed position P0.

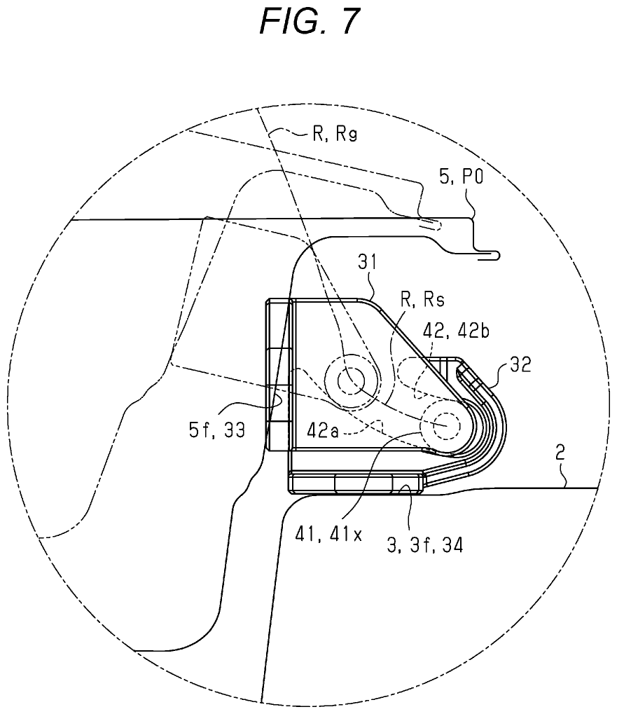

More specifically, the door engagement portion 31 of the present embodiment includes a shaft-shaped engagement portion 41 extending in the vertical direction (in FIG. 7, a direction orthogonal to the paper surface) of the vehicle 1 as the guide engagement portion. In the door device 20 of the present embodiment, the shaft-shaped engagement portion 41 as the guide engagement portion has a configuration as a roller 41x rotatably supported around a support shaft (not illustrated) extending in the vertical direction. Further, the vehicle body engagement portion 32 includes a guide groove 42 having a pair of side wall portions 42a and 42b facing each other in the vehicle width direction (in FIG. 7, the vertical direction) and extending in the opening and closing operation direction of the door 5. When the door 5 is in the vicinity of the fully closed position P0, the door device 20 of the present embodiment is configured such that the door engagement portion 31 and the vehicle body engagement portion 32 are engaged with each other in a state where the shaft-shaped engagement portion 41 constituting the guide engagement portion is disposed in the guide groove 42.

That is, the shaft-shaped engagement portion 41 of the door engagement portion 31 is disposed in the guide groove 42 of the vehicle body engagement portion 32 in a state of being sandwiched between the pair of side wall portions 42a and 42b facing each other in the vehicle width direction, whereby the displacement of the door 5 in the vehicle width direction is restricted. Thus, the door device 20 of the present embodiment can stably support the door 5 even in the vicinity of the fully closed position P0 where the first and second link arms 11 and 12 forming the link mechanism 15 are likely to be linearly disposed.

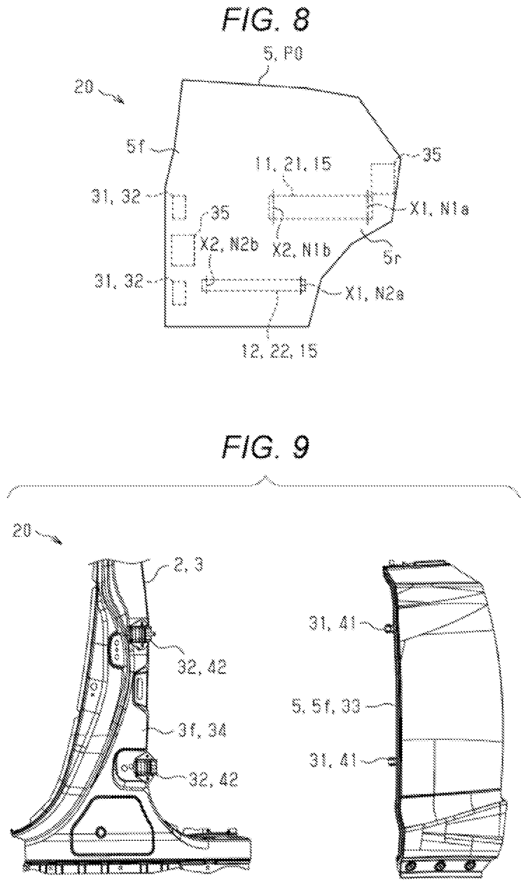

As illustrated in FIGS. 8 and 9, the door device 20 of the present embodiment includes the door engagement portions 31 and 31 provided at the front end 5f of the door 5 at two positions away from each other in the vertical direction. Further, the door device 20 includes the vehicle body engagement portions 32 and 32 provided at the front edge 3f of the door opening 3 at two positions away from each other in the vertical direction. The door device 20 of the present embodiment is configured to hold the door 5 at the fully closed position P0 in a state where the door engagement portions 31 and 31 and the vehicle body engagement portions 32 and 32 are engaged with each other.

In addition, the door device 20 of the present embodiment includes lock devices 35 and 35 provided at the front end 5f and the rear end 5r of the door 5. The door device 20 of the present embodiment is configured such that the latch mechanism (not illustrated) constituting each lock device 35 is engaged with a striker (not illustrated) provided in the vehicle body 2, whereby the door 5 is restrained at the fully closed position P0.

As illustrated in FIGS. 3 to 6, in the door device 20 of the present embodiment, the second link arm 12 served as the sub-link 22 is provided with a connection length variable mechanism 50 that allows a connection length L between the first and second rotation connection points X1 and X2 to change. Further, the connection length variable mechanism 50 is biased in a direction of shortening the length between the first and second rotation connection points X1 and X2, that is, the connection length L of the door 5 by the second link arm 12 provided with the connection length variable mechanism 50. Then, the door device 20 of the present embodiment is configured such that the door 5 is opened and closed in a state where the connection length L by the second link arm 12 is shortened.

As illustrated in FIGS. 3, 4, and 7, in the door device 20 of the present embodiment, the opening and closing operation of the door 5 in a state where the door engagement portion 31 and the vehicle body engagement portion 32 are engaged with each other is allowed based on the operation of the connection length variable mechanism 50 provided in the second link arm 12. Specifically, when the door 5 is opened and closed in a state where the door engagement portion 31 and the vehicle body engagement portion 32 are engaged with each other, the shaft-shaped engagement portion 41 is relatively displaced along the extending direction of the guide groove 42 along with the change in the connection length L based on the operation of the connection length variable mechanism 50. Then, in the door device 20 of the present embodiment, the opening and closing operation trajectory R of the door 5 changes accordingly.

That is, in the door device 20 of the present embodiment, when the door 5 moves to the fully closed position P0, the door engagement portion 31 is correctly engaged with the vehicle body engagement portion 32, so that the opening and closing operation of the door 5 is guided in a state where the shaft-shaped engagement portion 41 is disposed in the guide groove 42. The door device 20 according to the present embodiment is thus configured such that the arc-shaped trajectory Rg based on the operation of the link mechanism 15 changes to a linear trajectory Rs along the opening width direction of the door opening 3.

Specifically, in the door device 20 of the present embodiment, at the time of the full-closing operation of the door 5, the operating force in the closing operation direction is applied to the door 5 in a state where the door engagement portion 31 and the vehicle body engagement portion 32 are engaged with each other. In the door device 20 of the present embodiment, the driving force of the actuator 25 or the manual operation of the user is assumed as the operating force for opening and closing the door 5. Furthermore, in this case, the connection length variable mechanism 50 provided in the second link arm 12 operates based on the operating force in the closing operation direction, whereby the connection length L of the door 5 by the second link arm 12 is extended based on the engagement state between the door engagement portion 31 and the vehicle body engagement portion 32. Thus, the door device 20 of the present embodiment is configured such that the door 5 supported by the link mechanism 15 performs the closing operation toward the fully closed position P0 in the mode of drawing the linear trajectory Rs as described above.

When the door 5 performs the opening operation from the fully closed position P0, the operating force in the opening operation direction is applied to the door 5 in a state where the door engagement portion 31 and the vehicle body engagement portion 32 are engaged with each other. Furthermore, in this case, the connection length variable mechanism 50 operates based on the operating force in the opening operation direction, whereby the connection length L of the door 5 by the second link arm 12 is shortened based on the engagement state between the door engagement portion 31 and the vehicle body engagement portion 32. Thus, the door device 20 of the present embodiment is configured such that the door 5 supported by the link mechanism 15 performs the opening operation from the fully closed position P0 in the mode of drawing the linear trajectory Rs.

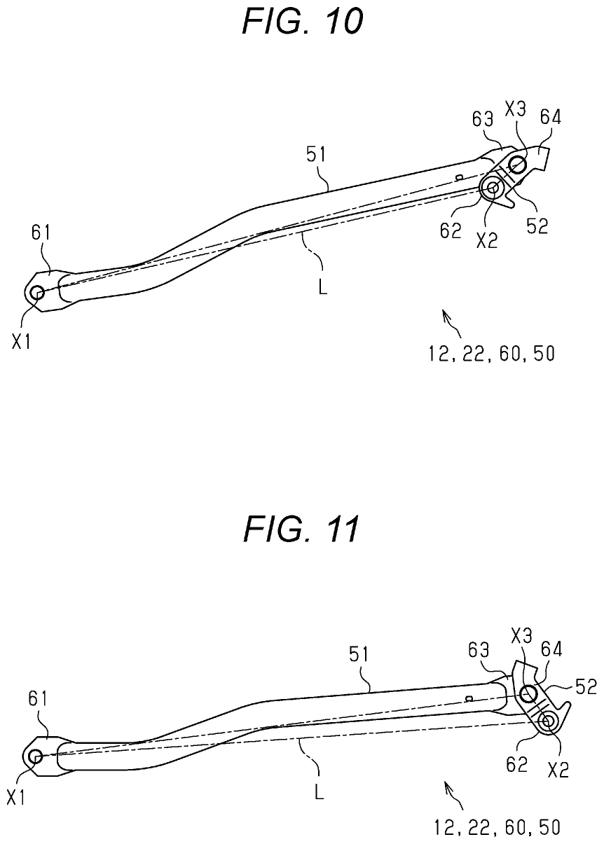

More specifically, as illustrated in FIGS. 10 and 11, in the door device 20 of the present embodiment, the second link arm 12 includes a vehicle body link 51 and a door link 52. That is, the vehicle body link 51 has the first rotation connection point X1 with respect to the vehicle body 2. The door link 52 has the second rotation connection point X2 with respect to the door 5 of the vehicle 1. Furthermore, in the door device 20 of the present embodiment, the second link arm 12 has a configuration in which the vehicle body link 51 and the door link 52 are rotatably connected. Further, the door device 20 of the present embodiment is configured such that a joint link mechanism 60 formed by this functions as the connection length variable mechanism 50.

Specifically, the door link 52 of the present embodiment has a configuration as a so-called mini arm having a short axial length in comparison with the vehicle body link 51. Further, the vehicle body link 51 has a vehicle body connection portion 61 with respect to the vehicle body 2 at one end in the longitudinal direction. Further, the door link 52 also has a door connection portion 62 with respect to the door 5 at one end in the longitudinal direction. The vehicle body link 51 and the door link 52 have intermediate connection portions 63 and 64 connected to each other at the other end in the longitudinal direction.

That is, in the door device 20 of the present embodiment, the intermediate connection portions 63 and 64 form an intermediate connection point X3 of the joint link mechanism 60 provided in the second link arm 12. In the second link arm 12, the vehicle body link 51 and the door link 52 form a triangle with the intermediate connection point X3 as a vertex. As a result, the vehicle body link 51 and the door link 52 relatively rotate, so that the length of the straight line connecting the first and second rotation connection points X1 and X2, which are the bases of the triangle, that is, the connection length L thereof changes.

(Vehicle opening and closing body control device) Next, a function as the vehicle opening and closing body control device mounted on the door device 20 of the present embodiment will be described.

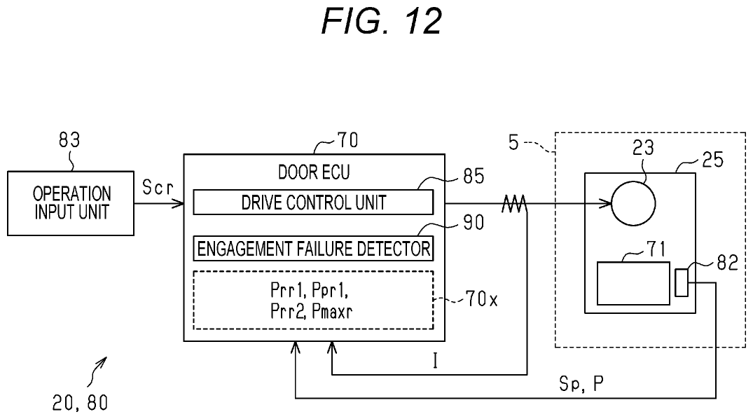

As illustrated in FIG. 12, in the door device 20 of the present embodiment, the operation of the actuator 25 is controlled by a door ECU 70. Specifically, the door ECU 70 of the present embodiment controls the supply of drive power to the motor 23 of the actuator 25. Furthermore, the actuator 25 of the present embodiment includes a transmission mechanism 71 that transmits the driving force of the motor 23 rotated by the supply of the drive power to the link mechanism 15. The door device 20 of the present embodiment thus has a function as a vehicle opening and closing body control device 80 that controls the opening and closing operation of the door 5 as the opening and closing body supported by the link mechanism 15 using the motor 23 as a drive source.

More specifically, the actuator 25 of the present embodiment is provided with a pulse sensor 82 that outputs a pulse signal Sp synchronized with the operation of the deceleration mechanism constituting the transmission mechanism 71. Then, the door ECU 70 of the present embodiment detects an opening and closing operation position P of the door 5 driven by the actuator 25 based on the pulse output of the pulse sensor 82.

Further, an output signal of an operation input unit 83 provided in the door 5, the vehicle interior, a portable device, or the like is input to the door ECU 70 of the present embodiment. That is, the door ECU 70 of the present embodiment detects an operation request of the door 5 by the user based on an operation input signal Scr output from the operation input unit 83. The door ECU 70 of the present embodiment includes a drive control unit 85 that controls the operation of the actuator 25 through the supply of the drive power to the motor 23 in order to move the door 5 in the requested opening and closing operation direction.

In addition, the door ECU 70 of the present embodiment detects the value of the current supplied to the motor 23 of the actuator 25, that is, the motor current value I. Further, the door ECU 70 monitors an opening and closing operation of the door 5 based on the detected motor current value I when the drive control unit 85 controls opening/closing of the door 5. That is, the motor current value I changes according to the load of the motor 23. The door ECU 70 according to the present embodiment is thus configured to execute appropriate operation control according to the detected abnormality of the door 5 when detecting the abnormality of the door 5 that opens and closes by using the motor 23 as a drive source.

For example, the door ECU 70 of the present embodiment reverses the opening and closing operation direction of the door 5 in a case where a foreign matter caught in the door 5 is detected when the door 5 is controlled to be opened or closed. The door device 20 of the present embodiment is thus configured to be able to quickly eliminate a foreign matter caught in the door 5.

As described above, the door device 20 of the present embodiment is configured such that when the door 5 is in the vicinity of the fully closed position P0, the door engagement portion 31 provided at the closed-side end 34 of the door 5 is engaged with the vehicle body engagement portion 32 provided at the closed-side end 33 of the door opening 3. The door ECU 70 according to the present embodiment includes an engagement failure detector 90 that detects a failure in engagement between the door engagement portion 31 and the vehicle body engagement portion 32 occurring in the door 5 at the time of full-closing control of the door 5 executed by the drive control unit 85.

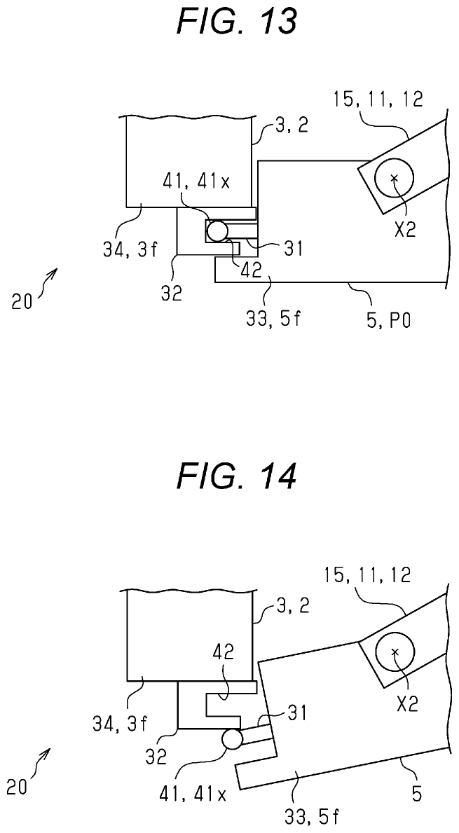

That is, as illustrated in FIG. 13, when the door 5 moves to the fully closed position P0, the door engagement portion 31 as the opening and closing body engagement portion is correctly engaged with the vehicle body engagement portion 32, whereby the shaft-shaped engagement portion 41 of the door engagement portion 31 is disposed in the guide groove 42 of the vehicle body engagement portion 32. The door device 20 of the present embodiment is configured such that the opening and closing operation of the door 5 supported by the link mechanism 15 is guided as described above (see FIG. 7).

However, as illustrated in FIG. 14, in the door device 20 of the present embodiment, the rotation of the door 5 is allowed around the second rotation connection point X2 with respect to the door 5 of the first and second link arms 11 and 12 constituting the link mechanism 15. Therefore, when an external force is input to the door 5 moving toward the fully closed position P0, the door 5 may swing. As a result, at the time of full-closing control of the door 5, there is a possibility that the door engagement portion 31 cannot be correctly engaged with the vehicle body engagement portion 32, that is, engagement failure in which the shaft-shaped engagement portion 41 of the door engagement portion 31 is not disposed in the guide groove 42 of the vehicle body engagement portion 32 occurs.

Based on this point, as illustrated in FIG. 12, in the door device 20 of the present embodiment, the engagement failure detector 90 provided in the door ECU 70 detects the failure in engagement of the door engagement portion 31 with the vehicle body engagement portion 32 generated at the time of full-closing control of the door 5. The door device 20 according to the present embodiment is thus configured to be able to correctly fully close the door 5 by motor drive.

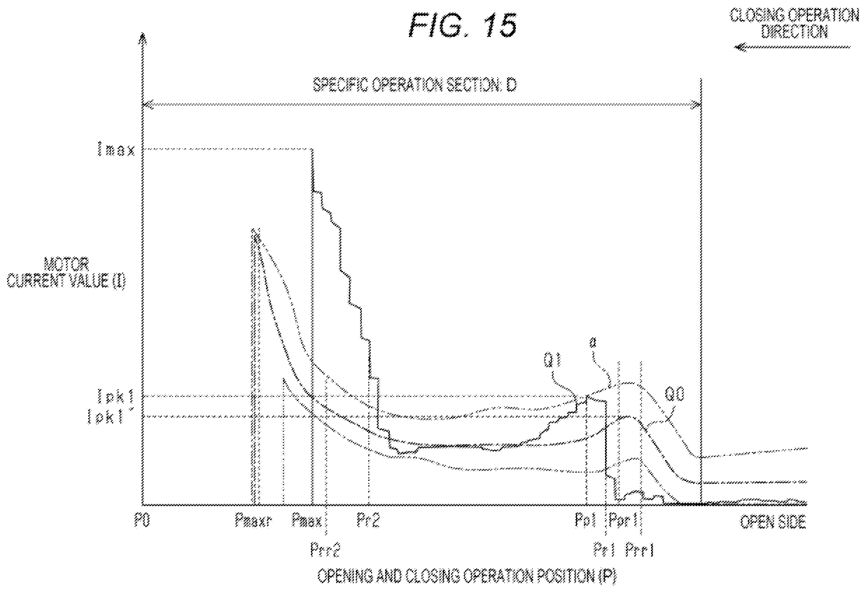

Specifically, as illustrated in FIG. 15, in the door device 20 of the present embodiment, a specific operation section D for the opening and closing operation position P of the door 5 is set in the vicinity of the fully closed position P0 where the door engagement portion 31 is engaged with the vehicle body engagement portion 32. Further, the door ECU 70 of the present embodiment monitors a change in the motor current value I caused by the entrance of the door 5 into the specific operation section D at the time of full-closing control of the door 5 by the drive control unit 85. The engagement failure detector 90 according to the present embodiment is configured to detect a failure in engagement of the door engagement portion 31 with the vehicle body engagement portion 32 based on a change in the motor current value I in the specific operation section D.

(Detection of failure in engagement of door engagement portion with vehicle body engagement portion) Next, detection of a failure in engagement of the door engagement portion 31 with the vehicle body engagement portion 32 executed by the door ECU 70 of the present embodiment will be described.

In FIG. 15, a waveform Q0 indicated by an alternate long and short dash line indicates a characteristic change that occurs in the motor current value I when the door engagement portion 31 is correctly engaged with the vehicle body engagement portion 32 at the time of full-closing control of the door 5. In the drawing, a band a indicated by parallel two-dot chain lines indicates a fluctuation range of the waveform of the motor current value I that changes with the same feature as the waveform Q0 when the door engagement portion 31 is correctly engaged with the vehicle body engagement portion 32 in this manner. In the drawing, a waveform Q1 indicated by a solid line indicates a change occurring in the motor current value I when a failure in engagement of the door engagement portion 31 with the vehicle body engagement portion 32 occurs at the time of full-closing control of the door 5.

That is, at the time of full-closing control of the door 5, the door 5 enters the specific operation section D, so that the door engagement portion 31 is engaged with the vehicle body engagement portion 32. As a result, the load of the motor 23 serving as the drive source increases, so that the motor current value I increases.

The motor current value I increased by the entrance of the door 5 into the specific operation section D once shows a peak, and then stably transitions to a value lower than the first peak value, that is, the first peak current values Ipk1 and Ipk1′. This is because, as described above, in the door device 20 of the present embodiment, even after the door engagement portion 31 is engaged with the vehicle body engagement portion 32, the engagement position is displaced, so that the closing operation of the door 5 toward the fully closed position P0 is allowed. Thereafter, the motor current value I increases again as the door 5 approaches the fully closed position P0.

That is, when the door 5 approaches the fully closed position P0, part of the door 5 contacts the door opening 3. As a result, the load of the motor 23 serving as the drive source increases, so that the motor current value I increases.

Specifically, in the door device 20 of the present embodiment, when the door 5 approaches the fully closed position P0, a seal member such as a weather strip (not illustrated) provided on the peripheral edge of the door 5 contacts the door opening 3. In addition, the drive control unit 85 of the present embodiment further continues the full-closing control of the door 5 from this state. The door device 20 according to the present embodiment is configured such that the door 5 moves in the closing operation direction while crushing the seal member contacting the door opening 3, thereby increasing the load on the motor 23 serving as the drive source.

That is, in the door device 20 of the present embodiment, the motor current value I increases with an increase in the load according to the repulsive force of the seal member crushed by the movement of the door 5 in the closing direction. The door device 20 according to the present embodiment is thus configured such that the increased motor current value I continuously updates the maximum value Imax at the opening and closing operation position P of the door 5 at which the closing drive of the door 5 using the motor 23 as a drive source ends.

Note that, in the door device 20 of the present embodiment, the closing drive of the door 5 using the motor 23 as a drive source is terminated at a position at which each of the latch mechanisms constituting the lock device 35 provided at the front end 5f and the rear end 5r of the door 5 is in the half latch state. Then, the door device 20 of the present embodiment is configured such that the latch mechanism of each lock device 35 is shifted from the half latched state to the full latched state by the operation of the closer device (not illustrated), whereby the full-closing control of moving the door 5 to the fully closed position P0 is completed.

Here, in FIG. 15, the waveform Q0 in a case where the door engagement portion 31 is correctly engaged with the vehicle body engagement portion 32 is compared with the waveform Q1 in a case where a failure in engagement of the door engagement portion 31 with the vehicle body engagement portion 32 occurs. As a result, when the failure in engagement of the door engagement portion 31 with the vehicle body engagement portion 32 occurs at the time of full-closing control of the door 5, it is possible to confirm that a deviation occurs in the occurrence timing of the characteristic change as described above occurring in the motor current value I.

Specifically, at the time of full-closing control of the door 5, when the failure in engagement of the door engagement portion 31 with the vehicle body engagement portion 32 occurs, the first rising timing of the motor current value I is delayed due to the entry of the door 5 into the specific operation section D. Conceivably this is because when the door engagement portion 31 is engaged with the vehicle body engagement portion 32 in a state where the shaft-shaped engagement portion 41 is not disposed in the guide groove 42 due to the swing of the door 5, the engagement timing of the door engagement portion 31 with the vehicle body engagement portion 32 is delayed. As a result, the same delay can be confirmed for the timing at which the first peak appears in the increased motor current value I thereafter.

Further, the second rising timing at which the motor current value I that once showed a peak rises again is earlier when the failure in engagement occurs than when the door engagement portion 31 is correctly engaged with the vehicle body engagement portion 32. Conceivably this is because when the failure in engagement of the door engagement portion 31 with the vehicle body engagement portion 32 occurs, the range in which the closing operation of the door 5 is allowed is narrowed in a state where the door engagement portion 31 and the vehicle body engagement portion 32 are engaged. Thereafter, the timing at which the increased motor current value I finally indicates the maximum value Imax is similarly earlier.

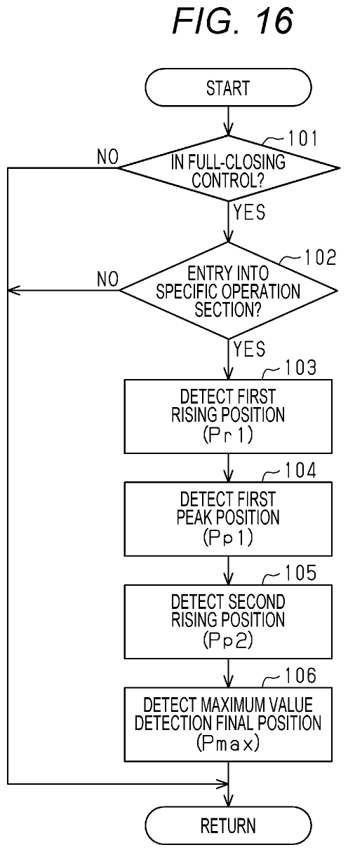

In view of this, as illustrated in FIGS. 15 and 16, the door ECU 70 according to the present embodiment determines whether the door 5 has entered the specific operation section D (step 102) when the drive control unit 85 performs full-closing control of the door 5 (step 101: YES). Next, after the door 5 enters the specific operation section D (step 102: YES), the door ECU 70 detects, as a first rising position Pr1, the opening and closing operation position P of the door 5 at which the first rising is detected in the motor current value I (step 103). The door ECU 70 then detects, as a first peak position Pp1, the opening and closing operation position P of the door 5 at which the increased motor current value I reaches a first peak (step 104). Next, after detecting the first peak position Pp1 in step 103, the door ECU 70 again detects, as a second rising position Pr2, the opening and closing operation position P of the door 5 at which a rise in the motor current value I is detected (step 105). The door ECU 70 according to the present exemplary embodiment then detects, as a maximum value detection final position Pmax, the opening and closing operation position P of the door 5 at which the increased motor current value I finally reaches the maximum value Imax (step 106).

Specifically, the detection determination of the first rising position Pr1 in step 103 is performed, for example, by comparing the increase amount per unit of the motor current value I, that is, the change rate of the increasing motor current value I with a predetermined determination threshold value. That is, the opening and closing operation position P of the door 5 at the time point when the increasing rate of the motor current value I exceeds the predetermined determination threshold value after the door 5 enters the specific operation section D can be detected as the first rising position Pr1 of the motor current value I detected first in the specific operation section D. The detection of the first rising position Pr1 can also be performed by comparing the increase amount, with respect to the reference value, detected in a situation where the motor current value I stably transitions at the time of low load before entering the specific operation section D with a predetermined determination threshold value set in advance for the increase amount. The detection of the first rising position Pr1 can be performed more simply by comparing the motor current value I detected after entering the specific operation section D with a predetermined determination threshold value set in advance for the detection value.

Further, the detection determination of the first peak position Pp1 in step 104 is performed based on, for example, an update history related to the maximum value Imax of the newly detected motor current value I after detection of first rising position Pr1. That is, when the maximum value Imax of the new motor current value I is not updated while the door 5 moves in the closing operation direction in the predetermined determination section, the maximum value Imax goes back to the opening and closing operation position P updated last and can be detected as the first peak position Pp1.

The detection determination of second rising position Pr2 in step 104 is performed by comparing the increasing rate of the motor current value I with a predetermined determination threshold value after detection of first peak position Pp1, as in the detection determination of first rising position Pr1. The detection determination of the second rising position Pr2 can be performed by comparing the increase amount, with respect to the reference value, detected in the situation where the motor current value I stably transitions after the detection of the first peak position Pp1 with the determination threshold value, or by comparing the motor current value I with the determination threshold value.

In this case, as each determination threshold value, a dedicated value set in advance for detection determination of the second rising position Pr2 is used. For comparison between the increase amount and the determination threshold value, for example, the average of the motor current value I that stably transitions at a value lower than the first peak current value Ipk1 after detection of the first peak position Pp1 may be used as the reference value. After the detection of the first peak position Pp1, when the detected motor current value I exceeds the first peak current value Ipk1, it can be detected as the second rising position Pr2 of the motor current value I detected second in the specific operation section D.

Furthermore, the detection determination of the maximum value detection final position Pmax in step 106 can be performed based on, for example, the update history regarding the maximum value Imax of the newly detected motor current value I after the detection of the second rising position Pr2. However, in the door device 20 of the present embodiment, as described above, the motor current value I indicates the maximum value Imax at the end of the closing drive of the door 5 using the motor 23 as the drive source due to the specifications. Therefore, the position where the closing driving of the door 5 is ended can be set as the maximum value detection final position Pmax.

As described above, after the door 5 enters the specific operation section D, the door ECU 70 of the present embodiment sequentially detects these characteristic changes in the motor current value I in association with the opening and closing operation position P at the time when the changes occurs. Further, when the door engagement portion 31 is correctly engaged with the vehicle body engagement portion 32 after entering the specific operation section D, the door ECU 70 of the present embodiment holds, as a reference value, a value corresponding to the opening and closing operation position P of the door 5 at which these characteristic changes occur in the motor current value I. Then, the engagement failure detector 90 of the present embodiment compares the detection value with the reference value to detect the failure in engagement of the door engagement portion 31 with the vehicle body engagement portion 32 based on the change in the motor current value I in the specific operation section D. Specifically, after the door 5 enters the specific operation section D, the failure in engagement of the door engagement portion 31 with the vehicle body engagement portion 32 occurring at the time of full-closing control is detected based on the occurrence timing of the characteristic change in the motor current value I.

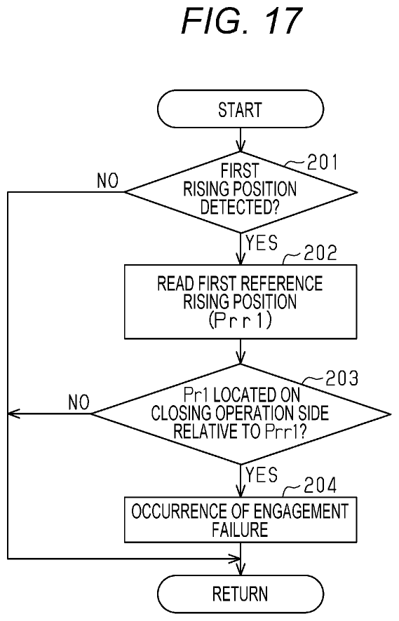

More specifically, as illustrated in FIG. 17, when the first rising position Pr1 is detected (step 201: YES), the engagement failure detector 90 of the present embodiment reads the first reference rising position Prr1 held in a storage area 70x of the door ECU 70 (step 202). That is, the first reference rising position Prr1 is a reference value set in advance corresponding to the opening and closing operation position P of the door 5 at which the rising of the motor current value I is detected first in the specific operation section D when the door engagement portion 31 is correctly engaged with the vehicle body engagement portion 32. Then, the engagement failure detector 90 compares the first reference rising position Prr1 read in step 202 with the first rising position Pr1 detected in step 201 (step 203).

That is, in step 203, the engagement failure detector 90 of the present embodiment determines whether the first rising position Pr1 that is the detection value is located on the closing operation side relative to the first reference rising position Prr1 that is the reference value. That is, it is determined whether the first rising timing of the motor current value I is delayed after the door 5 enters the specific operation section D (see FIG. 15). When the first rising position Pr1 is located on the closing operation side relative to the first reference rising position Prr1 (step 203: YES), the engagement failure detector 90 determines that the failure in engagement of the door engagement portion 31 with the vehicle body engagement portion 32 occurs (step 204).

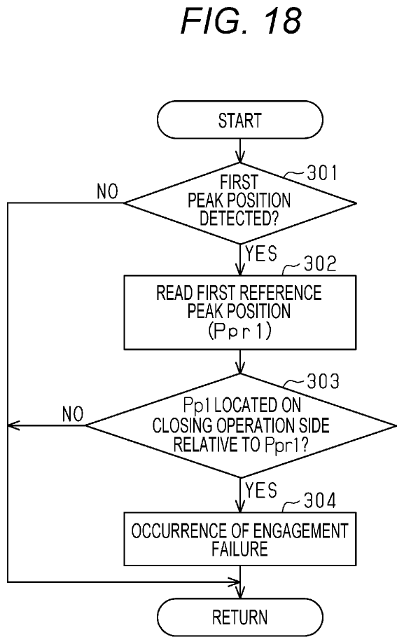

As illustrated in FIG. 18, when the first peak position Pp1 is detected (step 301: YES), the engagement failure detector 90 of the present embodiment reads the first reference peak position Ppr1 held in the storage area 70x of the door ECU 70 (step 302). That is, the first reference peak position Ppr1 is a reference value set in advance corresponding to the opening and closing operation position P of the door 5 at which the first peak appears in the motor current value I in the specific operation section D when the door engagement portion 31 is correctly engaged with the vehicle body engagement portion 32. Then, the engagement failure detector 90 compares the first reference peak position Ppr1 read in step 302 with the first peak position Pp1 detected in step 301 (step 303).

That is, in step 303, the engagement failure detector 90 of the present embodiment determines whether the first peak position Pp1 that is the detection value is located on the closing operation side relative to the first reference peak position Ppr1 that is the reference value. That is, after the door 5 enters the specific operation section D, it is determined whether there is a delay in the timing at which the first peak appears in the increased motor current value I (see FIG. 15). When the first peak position Pp1 is located on the closing operation side relative to the first reference peak position Ppr1 (step 303: YES), the engagement failure detector 90 determines that a failure in engagement of the door engagement portion 31 with the vehicle body engagement portion 32 occurs (step 304).

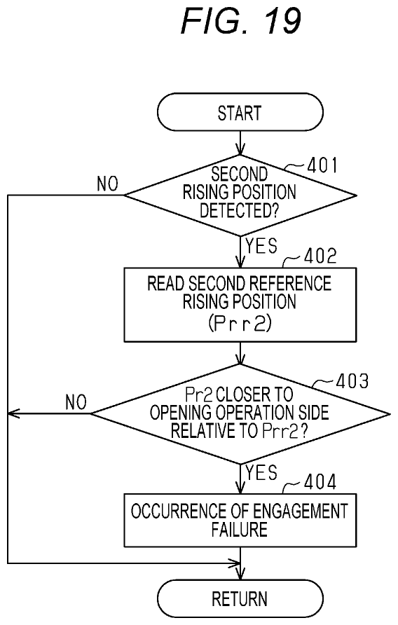

As illustrated in FIG. 19, when the second rising position Pr2 is detected (step 401: YES), the engagement failure detector 90 of the present embodiment reads a second reference rising position Prr2 held in the storage area 70x of the door ECU 70 (step 402). That is, the second reference rising position Prr2 is a reference value set in advance corresponding to the opening and closing operation position P of the door 5 at which the second rising of the motor current value I is detected in the specific operation section D when the door engagement portion 31 is correctly engaged with the vehicle body engagement portion 32. Then, the engagement failure detector 90 compares the second reference rising position Prr2 read in step 402 with the second rising position Pr2 detected in step 401 (step 403).

That is, in step 403, the engagement failure detector 90 of the present embodiment determines whether the second rising position Pr2 that is the detection value is closer to the opening operation side than the second reference rising position Prr2 that is the reference value. That is, after the door 5 enters the specific operation section D, it is determined whether the second rising timing generated in the motor current value I has come earlier (see FIG. 15). When the second rising position Pr2 is closer to the opening operation side than the second reference rising position Prr2 (step 403: YES), the engagement failure detector 90 determines that a failure in engagement of the door engagement portion 31 with the vehicle body engagement portion 32 occurs (step 404).

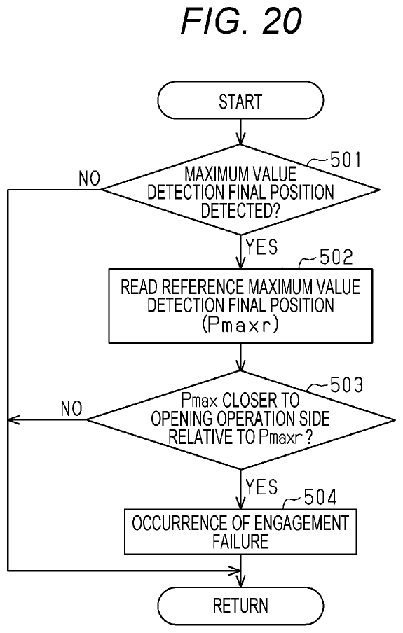

As illustrated in FIG. 20, when the maximum value detection final position Pmax is detected (step 501: YES), the engagement failure detector 90 of the present exemplary embodiment reads a reference maximum value detection final position Pmaxr held in storage area 70x of the door ECU 70 (step 502). That is, the reference maximum value detection final position Pmaxr is a reference value set in advance corresponding to the opening and closing operation position P of the door 5 at which the maximum value Imax of the motor current value I is last detected in the specific operation section D when the door engagement portion 31 is correctly engaged with the vehicle body engagement portion 32. Then, the engagement failure detector 90 compares the reference maximum value detection final position Pmaxr read in step 502 with the maximum value detection final position Pmax detected in step 501 (step 503).

That is, in step 503, the engagement failure detector 90 of the present embodiment determines whether the maximum value detection final position Pmax, which is the detection value, is closer to the opening operation side than the reference maximum value detection final position Pmaxr, which is the reference value. That is, after the door 5 enters the specific operation section D, it is determined whether the timing at which the maximum value Imax of the motor current value I is last detected has come earlier (see FIG. 15). When the maximum value detection final position Pmax is closer to the opening operation side than the reference maximum value detection final position Pmaxr (step 503: YES), the engagement failure detector 90 determines that a failure in engagement of the door engagement portion 31 with the vehicle body engagement portion 32 occurs (step 504).

When it is determined that a failure in engagement has occurred in any of the engagement failure determinations illustrated in FIGS. 17 to 20, the engagement failure detector 90 of the present embodiment detects a failure in engagement of the door engagement portion 31 with the vehicle body engagement portion 32. In each of the engagement failure determinations, the first reference rising position Prr1, the first reference peak position Ppr1, the second reference rising position Prr2, and the reference maximum value detection final position Pmaxr, which are the reference values, are set to optimum values by experiments, simulations, or the like. Door ECU 70 according to the present exemplary embodiment is configured to store these values in advance in storage area 70x (see FIG. 12).

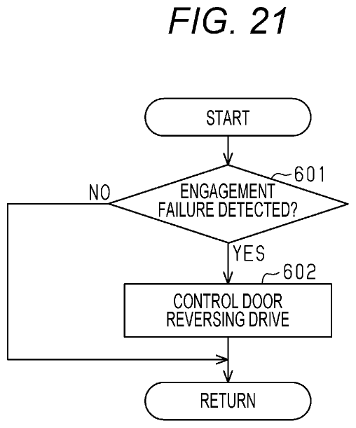

As illustrated in FIG. 21, when a failure in engagement of the door engagement portion 31 with the vehicle body engagement portion 32 is detected (step 601: YES), the door ECU 70 according to the present embodiment executes reverse control of the door 5 (step 602). That is, when the engagement failure detector 90 detects the engagement failure, the drive control unit 85 drives the door 5 to open. Thus, the door device 20 of the present embodiment is configured to be able to eliminate the failure in engagement of the door engagement portion 31 with the vehicle body engagement portion 32 generated at the time of full-closing control.

Next, the operation of the present embodiment will be described.

That is, in the specific operation section D in which the door engagement portion 31 is engaged with the vehicle body engagement portion 32 at the time of full-closing control of the door 5, the door 5 enters the specific operation section D, whereby a characteristic change occurs in the motor current value I. Then, in the door device 20 of the present embodiment, the failure in engagement of the door engagement portion 31 with the vehicle body engagement portion 32 is detected based on the change in the motor current value I in the specific operation section D.

A vehicle opening and closing body control device includes a drive control unit that opens and closes an opening and closing body of a vehicle using a motor as a drive source, wherein the opening and closing body performs the opening and closing operation based on an operation of a link mechanism formed by first and second link arms having a first rotation connection point with respect to a vehicle body and a second rotation connection point with respect to the opening and closing body, wherein an opening and closing body engagement portion is provided at a closed-side end of the opening and closing body, wherein a vehicle body engagement portion is provided at a closed-side end, of a vehicle body opening, that the closed-side end of the opening and closing body comes into contact with and separates from based on the opening and closing operation of the opening and closing body, wherein one of the opening and closing body engagement portion and the vehicle body engagement portion includes a guide engagement portion, wherein the other of the opening and closing body engagement portion and the vehicle body engagement portion includes a guide groove having a pair of side wall portions facing each other and extending in an opening and closing operation direction of the opening and closing body, wherein when the opening and closing body engagement portion is correctly engaged with the vehicle body engagement portion in a specific operation section set in a vicinity of a fully closed position of the opening and closing body, an opening and closing operation of the opening and closing body is guided in a state where the guide engagement portion is disposed in the guide groove, and an engagement failure detector that detects a failure in engagement of the opening and closing body engagement portion with the vehicle body engagement portion based on a change in a motor current value in the specific operation section at a time of full-closing control of the opening and closing body.

That is, the motor current value changes according to the load of the motor. Furthermore, in the specific operation section set in the vicinity of the fully closed position of the opening and closing body, the load of the motor serving as the drive source of the opening and closing body changes based on the engagement state between the opening and closing body engagement portion provided at the closed-side end of the opening and closing body and the vehicle body engagement portion provided at the closed-side end of the vehicle body opening. Accordingly, at the time of full-closing control of the opening and closing body, the engagement state of the opening and closing body engagement portion with the vehicle body engagement portion can be estimated based on the change in the motor current value in the specific operation section. Therefore, according to the above configuration, it is possible to accurately detect a failure in engagement of the opening and closing body engagement portion with the vehicle body engagement portion with a simple configuration. Thus, the opening and closing body can be properly fully closed.

In the vehicle opening and closing body control device, the specific operation section is part of an opening and closing operation position of the opening and closing body.

In the vehicle opening and closing body control device, it is preferable that the engagement failure detector detect the engagement failure based on the opening and closing operation position at which the characteristic change occurring in the motor current value occurs in the specific operation section.

That is, when the opening and closing body engagement portion is correctly engaged with the vehicle body engagement portion, a characteristic change occurs in the motor current value detected in the specific operation section at substantially the same timing every time. However, when the engagement failure occurs, a deviation occurs in the characteristic generation timing of the current change. Therefore, according to the above configuration, it is possible to accurately detect a failure in engagement of the opening and closing body engagement portion with the vehicle body engagement portion with a simple configuration.

In the vehicle opening and closing body control device, it is preferable that the engagement failure detector determine that the engagement failure occurs when a first rising position at which a rising of the motor current value is first detected in the specific operation section is located on a closing operation side relative to a preset first reference rising position.

That is, when the opening and closing body enters the specific operation section, the opening and closing body engagement portion is engaged with the vehicle body engagement portion. As a result, the load of the motor serving as the drive source increases, so that the first rising appears in the motor current value. However, when the failure in engagement of the opening and closing body engagement portion with the vehicle body engagement portion occurs, the first rising timing of the motor current value is likely to be delayed. Therefore, according to the above configuration, it is possible to accurately detect a failure in engagement of the opening and closing body engagement portion with the vehicle body engagement portion with a simple configuration.

In the vehicle opening and closing body control device, it is preferable that the engagement failure detector determine that the engagement failure occurs when a first peak position at which a peak of the motor current value is first detected in the specific operation section is located on a closing operation side relative to a preset first reference peak position.

That is, even after the opening and closing body engagement portion is engaged with the vehicle body engagement portion, the closing operation of the opening and closing body toward the fully closed position is allowed by the engagement position being displaced. As a result, the load of the motor is reduced, so that the first peak appears in the motor current value increased by the engagement of the opening and closing body engagement portion with the vehicle body engagement portion. However, when the failure in engagement of the opening and closing body engagement portion with the vehicle body engagement portion occurs, the timing at which the first peak appears is likely to be delayed. Therefore, according to the above configuration, it is possible to accurately detect a failure in engagement of the opening and closing body engagement portion with the vehicle body engagement portion with a simple configuration.

In the vehicle opening and closing body control device, it is preferable that the engagement failure detector determine that the engagement failure occurs when a second rising position at which a rising of the motor current value is second detected in the specific operation section is located on the opening operation side relative to a preset second reference rising position.

That is, when the opening and closing body approaches the fully closed position, part of the opening and closing body comes into contact with the vehicle body opening.

As a result, the load of the motor serving as the drive source increases, so that the motor current value increases. However, when the failure in engagement of the opening and closing body engagement portion with the vehicle body engagement portion occurs, the second rising timing of the motor current value tends to be early. Therefore, according to the above configuration, it is possible to accurately detect a failure in engagement of the opening and closing body engagement portion with the vehicle body engagement portion with a simple configuration.

In the vehicle opening and closing body control device, it is preferable that the engagement failure detector determine that the engagement failure occurs when a maximum value detection final position at which a maximum value of the motor current value is last detected in the specific operation section is located on an opening operation side relative to a preset reference maximum value detection final position.

That is, when the opening and closing body is driven to close while part of the opening and closing body is in contact with the vehicle body opening, the motor current value continuously updates the maximum value. When the failure in engagement of the opening and closing body engagement portion with the vehicle body engagement portion occurs, the timing at which the maximum value of the motor current value is last detected tends to be early. Therefore, according to the above configuration, it is possible to accurately detect a failure in engagement of the opening and closing body engagement portion with the vehicle body engagement portion with a simple configuration.

In the vehicle opening and closing body control device, it is preferable that the drive control unit reverses the opening and closing body when the engagement failure is detected.

According to the above configuration, it is possible to quickly eliminate the failure in engagement of the opening and closing body engagement portion with the vehicle body engagement portion generated at the time of full-closing control. Thus, the opening and closing body can be properly fully closed.

In the vehicle opening and closing body control device, it is preferable that the vehicle body opening is a door opening provided on a side face of the vehicle body, wherein the opening and closing body is a door that opens and closes the door opening, wherein the guide groove has the pair of side wall portions facing each other in a vehicle width direction, and wherein the guide engagement portion is a shaft-shaped engagement portion extending in a vertical direction of the vehicle.

According to the above configuration, the shaft-shaped engagement portion is disposed in the guide groove, whereby the displacement of the door in the vehicle width direction is restricted. As a result, the door can be stably supported even in the vicinity of the fully closed position where the distance between the first and second link arms is short and the first and second link arms are likely to be linearly disposed. However, when the door supported by the link mechanism swings due to input of an external force or the like, there is a possibility that a failure in engagement of the door engagement portion with the vehicle body engagement portion occurs. Therefore, by applying to such a configuration, a more remarkable effect can be obtained.

In the vehicle opening and closing body control device, it is preferable that at least one of the first and second link arms is provided with a connection length variable mechanism that allows a connection length between the first and second rotation connection points to change.

According to the above configuration, the degree of freedom of the opening and closing operation can be increased based on the operation of the connection length variable mechanism. As a result, the opening and closing body can be smoothly opened and closed in a state where the opening and closing body is guided by disposing the guide engagement portion in the guide groove. However, since the degree of freedom of the opening and closing operation is increased based on the operation of the connection length variable mechanism, the swing of the opening and closing body tends to be large. As a result, a failure in engagement of the opening and closing body engagement portion with the vehicle body engagement portion easily occurs. Therefore, by applying to such a configuration, a more remarkable effect can be obtained.

Next, effects of the present embodiment will be described.

(1) The door device 20 has a function as the vehicle opening and closing body control device 80 by controlling the operation of the actuator 25 by the door ECU 70. The door ECU 70 includes the drive control unit 85 that opens and closes the door 5 of the vehicle 1 using the motor 23 as a drive source. The door 5 as an opening and closing body performs an opening and closing operation based on the operation of the link mechanism 15 formed by the first and second link arms 11 and 12 having the first rotation connection point X1 with respect to the vehicle body 2 and the second rotation connection point X2 with respect to the door 5. The door engagement portion 31 including a shaft-shaped engagement portion 41 is provided at the closed-side end 33 of the door 5, and the vehicle body engagement portion 32 including the guide groove 42 having a pair of side wall portions 42a and 42b facing each other and extending in the opening and closing operation direction of the door 5 is provided at the closed-side end 34 of the door opening 3. Furthermore, in the specific operation section D set in the vicinity of the fully closed position P0 of the door 5, the door engagement portion 31 as the guide engagement portion is correctly engaged with the vehicle body engagement portion 32, so that the opening and closing operation of the door 5 is guided in a state where the shaft-shaped engagement portion 41 is disposed in the guide groove 42. The door ECU 70 includes the engagement failure detector 90 that detects a failure in engagement of the door engagement portion 31 with the vehicle body engagement portion 32 based on a change in the motor current value I in the specific operation section D at the time of full-closing control of the door 5.

That is, the motor current value I changes according to the load of the motor 23. Furthermore, in the specific operation section D set in the vicinity of the fully closed position P0 of the door 5, the load of the motor 23 serving as the drive source changes based on the engagement state between the door engagement portion 31 provided at the closed-side end 33 of the door 5 and the vehicle body engagement portion 32 provided at the closed-side end 34 of the door opening 3. Accordingly, the engagement state of the door engagement portion 31 with the vehicle body engagement portion 32 can be estimated based on the change in the motor current value I in the specific operation section D at the time of full-closing control of the door 5. Therefore, according to the above configuration, it is possible to accurately detect a failure in engagement of the door engagement portion 31 with the vehicle body engagement portion 32 with a simple configuration. Thus, the door 5 can be properly fully closed.

(2) The engagement failure detector 90 detects a failure in engagement of the door engagement portion 31 with the vehicle body engagement portion 32 based on an occurrence timing of a characteristic change in the motor current value I in the specific operation section D.

That is, when the door engagement portion 31 is correctly engaged with the vehicle body engagement portion 32, a characteristic change occurs in the motor current value I detected in the specific operation section D at substantially the same timing every time. However, when the engagement failure occurs, a deviation occurs in the characteristic generation timing of the current change. Therefore, according to the above configuration, it is possible to accurately detect a failure in engagement of the door engagement portion 31 with the vehicle body engagement portion 32 with a simple configuration.

(3) The engagement failure detector 90 determines that the engagement failure occurs when the first rising position Pr1 where the rising of the motor current value I is first detected in the specific operation section D is located on the closing operation side relative to the preset first reference rising position Prr1.

That is, when the door 5 enters the specific operation section D, the door engagement portion 31 is engaged with the vehicle body engagement portion 32. As a result, the load of the motor 23 serving as the drive source increases, so that the first rising appears in the motor current value I. However, when the failure in engagement of the door engagement portion 31 with the vehicle body engagement portion 32 occurs, the first rising timing generated in the motor current value I is likely to be delayed. Therefore, according to the above configuration, it is possible to accurately detect a failure in engagement of the door engagement portion 31 with the vehicle body engagement portion 32 with a simple configuration.

(4) The engagement failure detector 90 determines that the engagement failure occurs when the first peak position Pp1 at which the peak of the motor current value I is first detected in the specific operation section D is located on the closing operation side relative to the preset first reference peak position Ppr1.

That is, even after the door engagement portion 31 is engaged with the vehicle body engagement portion 32, the engagement position is displaced, so that the closing operation of the door 5 toward the fully closed position P0 is allowed. As a result, the load of the motor 23 decreases, so that the first peak appears in the motor current value I increased by the engagement of the door engagement portion 31 with the vehicle body engagement portion 32. However, when the failure in engagement of the door engagement portion 31 with the vehicle body engagement portion 32 occurs, the timing at which the first peak appears is likely to be delayed. Therefore, according to the above configuration, it is possible to accurately detect a failure in engagement of the door engagement portion 31 with the vehicle body engagement portion 32 with a simple configuration.

(5) When the second rising position Pr2 at which the second rising of the motor current value I is detected in the specific operation section D is closer to the opening operation side than the preset second reference rising position Prr2, the engagement failure detector 90 determines that an engagement failure has occurred.

That is, when the door 5 approaches the fully closed position P0, part of the door 5 contacts the door opening 3. As a result, the load of the motor 23 serving as the drive source increases, so that the motor current value I increases. However, when the failure in engagement of the door engagement portion 31 with the vehicle body engagement portion 32 occurs, the second rising timing generated in the motor current value I tends to be early. Therefore, according to the above configuration, it is possible to accurately detect a failure in engagement of the door engagement portion 31 with the vehicle body engagement portion 32 with a simple configuration.

(6) The engagement failure detector 90 determines that the engagement failure occurs when the maximum value detection final position Pmax where the maximum value Imax of the motor current value I is last detected in the specific operation section D is closer to the opening operation side than the preset reference maximum value detection final position Pmaxr.

That is, when the door 5 is driven to close while part of the door 5 is in contact with the door opening 3, the motor current value I continuously updates the maximum value Imax. When the failure in engagement of the door engagement portion 31 with the vehicle body engagement portion 32 occurs, the timing at which the maximum value Imax of the motor current value I is last detected tends to be early. Therefore, according to the above configuration, it is possible to accurately detect a failure in engagement of the door engagement portion 31 with the vehicle body engagement portion 32 with a simple configuration.

(7) When a failure in engagement of the door engagement portion 31 with the vehicle body engagement portion 32 is detected, the drive control unit 85 reverses the door 5.

According to the above configuration, it is possible to quickly eliminate the failure in engagement of the door engagement portion 31 with the vehicle body engagement portion 32 generated at the time of full-closing control. Thus, the door 5 can be properly fully closed.

(8) The guide groove 42 has a pair of side wall portions 42a and 42b facing each other in the vehicle width direction. The shaft-shaped engagement portion 41 as a guide engagement portion extends in the vertical direction of the vehicle 1.

According to the above configuration, the shaft-shaped engagement portion 41 is disposed in the guide groove 42, whereby the displacement of the door 5 in the vehicle width direction is restricted. As a result, the door 5 can be stably supported even in the vicinity of the fully closed position P0 where the distance between the first and second link arms 11 and 12 is short and the first and second link arms are likely to be linearly disposed. However, when the door 5 supported by the link mechanism 15 swings due to input of an external force or the like, there is a possibility that a failure in engagement of the door engagement portion 31 with the vehicle body engagement portion 32 occurs. Therefore, by applying to such a configuration, a more remarkable effect can be obtained.

(9) The second link arm 12 is provided with the connection length variable mechanism 50 that allows the connection length L between the first and second rotation connection points X1 and X2 to change.

According to the above configuration, the degree of freedom of the opening and closing operation can be increased based on the operation of the connection length variable mechanism 50. As a result, the door 5 can be smoothly opened and closed in a state where the door 5 is guided by disposing the shaft-shaped engagement portion 41 in the guide groove 42. However, since the degree of freedom of the opening and closing operation is increased based on the operation of the connection length variable mechanism 50, the swing of the door 5 tends to be large. As a result, a failure in engagement of the door engagement portion 31 with the vehicle body engagement portion 32 is likely to occur. Therefore, by applying to such a configuration, a more remarkable effect can be obtained.

The above embodiment can be modified as follows. The above embodiment and the following modification examples can be implemented in combination with each other within a range not technically contradictory.
In the above embodiment, each engagement failure determination based on the detection of the first rising position Pr1, the first peak position Pp1, the second rising position Pr2, and the maximum value detection final position Pmax is executed. When it is determined that a failure in engagement has occurred in any of these engagement failure determinations, a failure in engagement of the door engagement portion 31 with the vehicle body engagement portion 32 is detected. However, the present disclosure is not limited thereto, and anyone, any two, or any three of the engagement failure determinations based on these characteristic changes in the motor current value I may be executed in the specific operation section D.
The detection of the failure in engagement may be confirmed by combining a plurality of engagement failure determinations. For example, when it is determined that a failure in engagement occurs in the engagement failure determination based on the detection of the first rising position Pr1, and it is determined that a failure in engagement occurs in the engagement failure determination based on the detection of the first peak position Pp1, the failures in engagement may be detected.
Further, other than the detection of the first rising position Pr1, the first peak position Pp1, the second rising position Pr2, and the maximum value detection final position Pmax, the engagement failure determination may be performed by detection of a characteristic change in the motor current value I. That is, the characteristic change in the motor current value I used for the engagement failure determination may be set in any manner, and any method of detecting the characteristic change may be used. The reference value used for the engagement failure determination may be set in any manner.
In the above embodiment, after the door 5 enters the specific operation section D, a characteristic change in the motor current value I is detected in association with the opening and closing operation position P of the door 5 at the time of occurrence.
   Thus, the failure in engagement of the door engagement portion 31 with the vehicle body engagement portion 32 is detected based on the occurrence timing of the characteristic change in the motor current value I in the specific operation section D. However, the present disclosure is not limited thereto, and a configuration may be employed in which a characteristic change in the motor current value I in the specific operation section D is detected in association with an elapsed time after the door 5 enters the specific operation section D.
The configuration may be such that a failure in engagement of the door engagement portion 31 with the vehicle body engagement portion 32 is detected based on the magnitude of the change in the motor current value I in the specific operation section D regardless of the occurrence timing. The failure in engagement of the door engagement portion 31 with the vehicle body engagement portion 32 may be detected by a combination of the characteristic change occurrence timing and the magnitude of the change.
In the above embodiment, the engagement failure determination is performed by comparing the detection value detected after the door 5 enters the specific operation section D with the reference value set in advance corresponding to the case where the door engagement portion 31 is correctly engaged with the vehicle body engagement portion 32. However, the present disclosure is not limited thereto, and as long as the failure in engagement is detected based on the change in the motor current value I in the specific operation section D, the method of determining the failure in engagement may be changed in any manner, for example, the determination is directly made from the changed waveform the using the determination model generated by machine learning.
In the above embodiment, when the failure in engagement of the door engagement portion 31 with the vehicle body engagement portion 32 is detected, the reverse control of the door 5 is executed. However, the present disclosure is not limited thereto, and the door 5 may be driven in the opening operation direction by executing the reverse control to eliminate the failure in engagement, and then the door 5 may be configured to have a so-called retry function of executing the full-closing control again. Further, when an engagement failure is detected, a warning sound or a warning display indicating the occurrence of the engagement failure may be output. Then, by outputting such a warning without performing the reverse control, the user may be urged to execute an operation for eliminating the failure in engagement.
In the above embodiment, the door engagement portion 31 has the shaft-shaped engagement portion 41 as the guide engagement portion, and the vehicle body engagement portion 32 has the guide groove 42. However, the present disclosure is not limited thereto, and the door engagement portion 31 may have the guide groove 42, and the vehicle body engagement portion 32 may have the shaft-shaped engagement portion 41.
Further, the shaft-shaped engagement portion 41 has a configuration as the roller 41x rotatably supported around the support shaft, but the shaft-shaped engagement portion 41 may not rotate. Furthermore, the guide engagement portion does not necessarily have a shaft shape. The guide groove 42 may also be changed in any shape. That is, it is sufficient that when the door engagement portion 31 as the opening and closing body engagement portion is correctly engaged with the vehicle body engagement portion 32, the opening and closing operation of the door 5 is guided in a state where the guide engagement portion is disposed in the guide groove 42.
In the above embodiment, the door device 20 is embodied in which the door opening 3 provided in the side face 2s of the vehicle body 2 is a vehicle body opening, and the door 5 provided in the door opening 3 is opened and closed. However, the present disclosure is not limited thereto, and for example, the present disclosure may be applied to a configuration in which an opening and closing body provided in a vehicle body opening other than the door opening 3, such as a rear hatch opening to the rear of the vehicle 1, is opened and closed.
In the above embodiment, the connection length variable mechanism 50 is provided in the second link arm 12. However, the present disclosure is not limited thereto, and may be applied to a configuration in which the connection length variable mechanism 50 is provided in the first link arm 11. The present disclosure may be applied to a configuration in which the connection length variable mechanism 50 is provided in both the first and second link arms 11 and 12.
In the embodiment described above, the connection length variable mechanism 50 has a configuration as the joint link mechanism 60 formed by rotatably connecting the vehicle body link 51 having the first rotation connection point X1 and the door link 52 having the second rotation connection point X2. However, the present disclosure is not limited to this, and the connection length variable mechanism 50 may be changed to have any configuration such as using a direct-acting expansion/contraction link mechanism or the like. As long as the door engagement portion 31 is correctly engaged with the vehicle body engagement portion 32 to guide the opening and closing operation of the door 5 in a state where the guide engagement portion is disposed in the guide groove 42, the connection length variable mechanism 50 may not be provided.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle opening and closing body control device comprising:
a drive control unit that opens and closes an opening and closing body of a vehicle using a motor as a drive source; wherein
the opening and closing body performs the opening and closing operation based on an operation of a link mechanism formed by first and second link arms having a first rotation connection point with respect to a vehicle body and a second rotation connection point with respect to the opening and closing body,
an opening and closing body engagement portion is provided at a closed-side end of the opening and closing body,
a vehicle body engagement portion is provided at a closed-side end of a vehicle body opening, that the closed-side end of the opening and closing body comes into contact with and separates from based on the opening and closing operation of the opening and closing body,
one of the opening and closing body engagement portion and the vehicle body engagement portion includes a guide engagement portion,
the other of the opening and closing body engagement portion and the vehicle body engagement portion includes a guide groove having a pair of side wall portions facing each other and extending in an opening and closing operation direction of the opening and closing body, and
when the opening and closing body engagement portion is correctly engaged with the vehicle body engagement portion in a specific operation section set in a vicinity of a fully closed position of the opening and closing body, an opening and closing operation of the opening and closing body is guided in a state where the guide engagement portion is disposed in the guide groove; and
an engagement failure detector that detects a failure in engagement of the opening and closing body engagement portion with the vehicle body engagement portion based on a change in a motor current value in the specific operation section at a time of full-closing control of the opening and closing body.

2. The vehicle opening and closing body control device according to claim 1, wherein
the specific operation section is part of an opening and closing operation position of the opening and closing body.

3. The vehicle opening and closing body control device according to claim 2, wherein
the engagement failure detector detects the engagement failure based on the opening and closing operation position at which a characteristic change in the motor current value occurs in the specific operation section.

4. The vehicle opening and closing body control device according to claim 3, wherein
the engagement failure detector determines that the engagement failure occurs when a first rising position at which a rising of the motor current value is first detected in the specific operation section is located on a closing operation side relative to a preset first reference rising position.

5. The vehicle opening and closing body control device according to claim 3, wherein
the engagement failure detector determines that the engagement failure occurs when a first peak position at which a peak of the motor current value is first detected in the specific operation section is located on a closing operation side relative to a preset first reference peak position.

6. The vehicle opening and closing body control device according to claim 3, wherein
the engagement failure detector determines that the engagement failure occurs when a second rising position at which a rising of the motor current value is second detected in the specific operation section is located on the opening operation side relative to a preset second reference rising position.

7. The vehicle opening and closing body control device according to claim 3, wherein
the engagement failure detector determines that the engagement failure occurs when a maximum value detection final position at which a maximum value of the motor current value is last detected in the specific operation section is located on an opening operation side relative to a preset reference maximum value detection final position.

8. The vehicle opening and closing body control device according to claim 1, wherein
the drive control unit reverses the opening and closing body when the engagement failure is detected.

9. The vehicle opening and closing body control device according to claim 1, wherein
the vehicle body opening is a door opening provided on a side face of the vehicle body, wherein
the opening and closing body is a door that opens and closes the door opening, wherein
the guide groove has the pair of side wall portions facing each other in a vehicle width direction, and wherein
the guide engagement portion is a shaft-shaped engagement portion extending in a vertical direction of the vehicle.

10. The vehicle opening and closing body control device according to claim 1, wherein
at least one of the first and second link arms is provided with a connection length variable mechanism that allows a connection length between the first and second rotation connection points to change.
